(19) United States
(12) Patent Application Publication
(10) Pub. No.: US 2004/0195752 A1
(43) Pub. Date: Oct. 7, 2004

(54) Clamping apparatus with linear indexed device

(75) Inventor: Luciano Migliori, Milan (IT)

Correspondence Address: YOUNG & THOMPSON, 745 SOUTH 23RD STREET 2ND FLOOR, ARLINGTON, VA, 22202

(73) Assignee: UNIVER S.P.A., MILAN (IT)

(21) Appl. No.: 10/812,968

(22) Filed: Mar. 31, 2004

(30) Foreign Application Priority Data
Apr. 4, 2003 (IT) MI2003A 000667

(51) Int. Cl. B25B 5/10

(52) U.S. Cl. 269/244

(57) ABSTRACT

The apparatus comprises a box shaped body and a clamping member, movably supported between first and second operative positions to lock and respectively release a work piece. A linear detecting device generates a set of control signals for a control unit, during the movement between the operative positions of the clamping arm. The detecting device comprises a first and a second sensor and indexing means in the form of a comb-shaped member having spaced apart teeth to sequentially activate the sensors and provide the set of control signals during the movement of the clamping member.

### BACKGROUND OF THE INVENTION

This invention refers to a clamping apparatus for clamping or gripping and centering work pieces, normally used in the automation and automotive industry, provided with a movable member in the form of a pivotable arm, hook shaped member or centering and gripping stud for retaining a workpiece, hereinafter referred to as “clamping member”, and an indexing system for detecting and controlling the movement and a number of operative positions of the clamping member of the device.

### STATE OF THE ART

Clamping or gripping apparatuses or devices of the aforementioned type usually, comprise a movable clamping member operatively connected to a pneumatic or electric actuator, and detecting means provided for supply a control unit with control signals indicative of operative positions of the movable clamping member at both ends of the working stroke.

Such clamping apparatuses are described for example in EP 0 243 599, EP 0 255 853 and WO 02/34473.

In general, a clamping apparatus of the abovementioned type comprises a box-shaped casing having a longitudinal axis, to which a movable clamping member, consisting for example of a clamping arm, is pivotally connected to the casing to rotate between first and second operative positions in which the clamping arm locks or respectively disengage a workpiece. The clamping member is operatively connected to an actuator by means of an articulated system and a linearly movable thrust member, of the extensible type, which moves parallel to or along the longitudinal axis of the box-shaped casing of the apparatus.

U.S. Pat. No. 6,199,873 and FR 2 789 616 relate to gripping and centering devices in which the clamping member is in the form of a hook-shaped member and respectively a centering stud.

Optical sensors, or any other type of detectors, are disposed inside the casing to provide control signals for detecting and controlling the clamping member, in correspondence with operative positions, at both ends of the working stroke.

U.S. Pat. No. 5,845,897 in turn merely suggests to adjust the space and the positions of the detecting sensors, in a pneumatically-operated apparatus, at the ends of the working stroke; nevertheless said document does not contemplate nor suggest any possibility of controlling the clamping member during the movement and in intermediate positions of the working stroke.

In certain applications however it is necessary to accurately control the clamping member in a number of working positions along its entere working stroke, and to govern its movement by an appropriate sequence of control signals corelated to various working positions that the clamping member may assume during its movement, throughout the entere working stroke.

The combined use of these types of clamping apparatuses with conventional signal generators or encoder, does not satisfactorily solve the problem, in that there is little likelihood of being housed in the casing of the clamping apparatus, and in that they would create additional obstruction which are not always acceptable wherever a relevant number of such clamping apparatuses is used on assembling lines in the presence of several moving mechanisms which could interfere with the clamping apparatus by colliding or damaging the same.

### OBJECTS OF THE INVENTION

The main object of this invention is to provide a clamping apparatus of the type referred to, comprising a detecting device for controlling the working stroke the clamping member, whereby it is possible to selectively provide a sequence of control signals for detecting the various working positions assumed by the clamping member during its working stroke, by means of a structurally simple and low cost solution.

A further object of the invention is to provide a clamping apparatus comprising a detecting device allowing an accurate and selective control of the clamping member along a working stroke made appropriately adjustable, while at the same time maintaining limited overall dimensions in the axial direction of the same clamping apparatus. Any outer obstruction is therefore eliminated, allowing a more controlled management of the working conditions.

### BRIEF DESCRIPTION OF THE INVENTION

More precisely, according to the invention, a clamping apparatus has been provided for clamping work pieces, the apparatus comprising:

a box-shaped casing having a longitudinal axis;

a clamping member, movably supported by the box-shaped casing;

said clamping member being operatively connected to a control actuator by a thrust member, to be moved between a first and a second operative position; and

a detector device for detecting the clamping member in its operative positions, said detector device comprising at least a first detecting sensor, and

sensor actuating means connected to the movable thrust member, wherein

the sensor actuating means comprises a plurality of spaced apart and side by side arranged indexing members, said indexing members being longitudianlly aligned on a side of the thrust member facing said sensor of the detector device.

Preferably, the sensor actuating means consist of a flat, comb-shaped element having a plurality of indexing teeth coplanary arranged to sequentially operate said sensor, at least one of the indexing teeth having a greater length and extending beyond the remaining indexing teeth of the detector device.

Further features of the clamping apparatus and related detector device are specified in the dependent claims.

### BRIEF DESCRIPTION OF THE DRAWINGS

These and further features of a clamping apparatus comprising a detecting device, according to the invention, and a preferential embodiment thereof, will be more clearly evident from the following description, with reference to the accompanying drawings, in which:

FIG. 1 is a partial cutaway view of a clamping apparatus, with a portion of the box-shaped casing removed to shows the internal detector device;

FIG. 2 shows an enlarged detail of the detector device of FIG. 1.

### DETAILED DESCRIPTION OF THE INVENTION

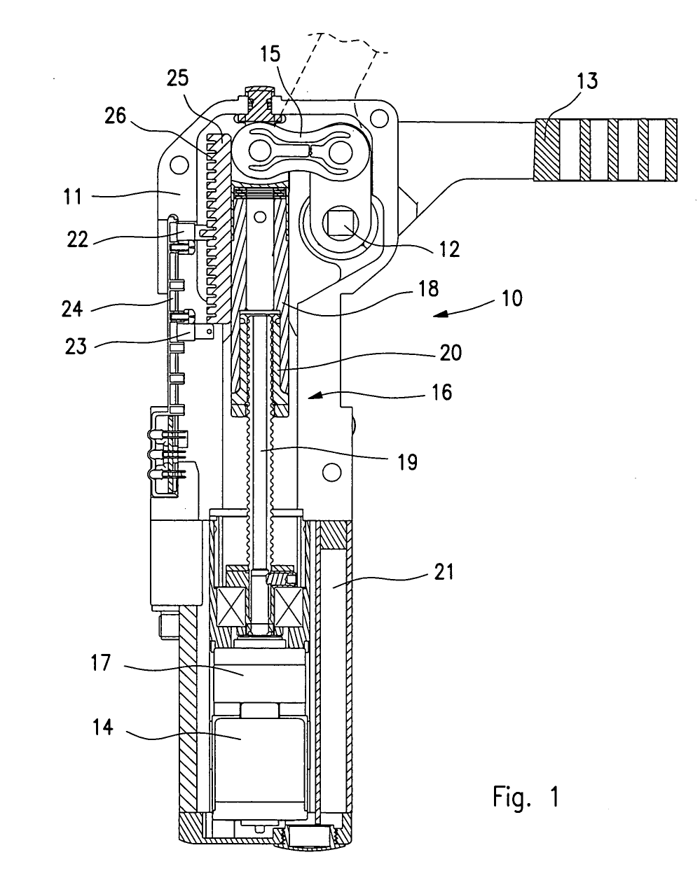

FIG. 1 of the drawings shows by way of example, an electrically-operated clamping apparatus, as a whole indicated by reference number 10; the clamping apparatus 10 comprises a box-shaped casing 11 to which a clamping member in the form of a clamping arm 13, is pivotally connected to angularly rotate between an open position, partially shown by phantom lines, in which the arm 13 disengage a work piece, not shown, and a closed position, shown by the continuous lines in FIG. 1, in which the clamping arm 13 locks a work piece against a frame or a shoulder surface, in a per se known way.

The clamping arm 13 is in turn operatively connected to an actuator, consisting for example of one or more electric motors 14, by means of an articulated system 15 and an axially extensible thrust member 16 movable in the longitudinal direction of the box-shaped casing 11.

In the example under consideration, the thrust member 16, in turn consists of a hollow rod 18 connected to the shaft 19 of a gear reduction unit 17 of the electric motor 14, by means of a nut-screw system. In the example of FIG. 1, the nut-screw system comprises a screw extending on the shaft 19 of the gear reduction unit 17, and a nut 20 inside the hollow rod 18; however, it is obvious that the disposition of the screw 19 and the nut 20 may also be reversed with respect to what shown.

The clamping device 10 also comprises a detector device for controlling the movement and detecting angular positions of the clamping arm 13, or more in general a number of working positions of the clamping member along its working stroke, between the two extreme open and closed positions, as shown.

More precisely, the detector device make it possible to provide an electronic control unit inside a seating 21 of the motor casing, with reference signals indicative of a plurality of operative positions that the clamping arm 13 can assume during movement between the two aforementioned extreme open and closed positions.

In the case shown, the position detector device for the clamping arm 13, comprise a first sensor 22, and a second sensor 23 adjustably supported by a cover plate 24 which is extending over a longitudinal slot, on a side wall of the casing 11; the cover plate 24 is provided with fastening bushes for removably fastening the sensors 22, 25 by a screw. Therefore the sensors 22, 23 may be adjustably fastened in a spaced apart relationship in the longitudinal direction of the thrust member 16, coinciding with or parallel to the longitudinal axis of the box-shaped casing 11 of the clamping apparatus.

The detector device for the clamping arm 13, also comprise indexing means for actuating the sensors 21 and 23, provided with a plurality of spaced apart and side by side arranged indexing members, longitudinally aligned on a side of the movable thrust member 18 facing the sensors 22, 23 of the detector device.

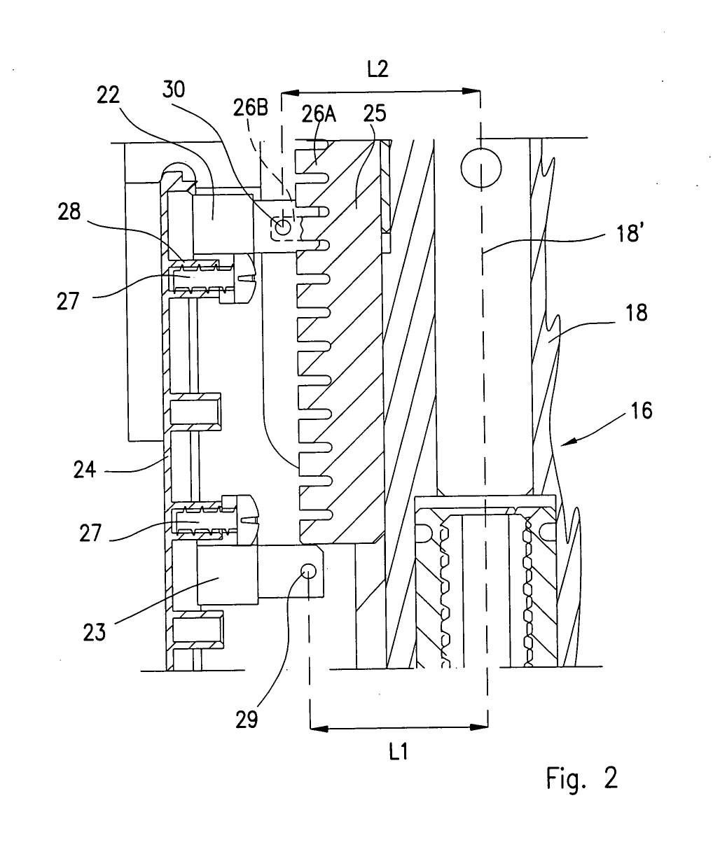

In the example of FIG. 2, the indexing means are in the form of a comb shaped member 25 secured to the rod 18 of the thrust member 16. The comb 25 is provided with a plurality of teeth 26A, 26B aligned with and spaced apart from one another in the direction of the axis 18′ of the thrust member 16, to selectively actuate the two sensors 22 and 23, providing a sequence of control signals for a control unit inside the seating 21.

More precisely, as shown in the enlarged detail of FIG. 2, the two sensors 22, 23, which can be of any suitable type, for example of optical type, are adjustably secured to the cover plate 24 by means of screws 27 which engage into bushes 28 on the inner side of the cover plate 24.

In the same FIG. 2 it can be seen that one of the sensors, in particular the sensor 23 which provides a position signal during the opening stroke of the clamping arm 13, has its light sensing element 29 at a first distance L1 from the axis 18′ of the thrust member 16.

Conversely, the other sensor 22 has its light sensing element 30 at a second distance L2 from the axis 18′, greater than the distance L1 for the sensor 23.

Since the sensor 22 provides a reference signal only in the closed position of the clamping arm 13, while the sensor 23 provides a sequence of reference signals, each indicative a respective operative position of the clamping arm 13, the comb member 25 is provided with a plurality of indexing teeth 26A of a first length to activate the sensor 23, and at least one indexing tooth 26B of a secong length greater than the first length of the previous indexing teeth 26A, by means of which both the sensors 22 and 23 are respectively activated during opening and closing movements of the clamping arm 13.

The indexing tooth 26B for the sensor 22 relating to the closed position of the clamping arm 13, can be provided in any longitudinal position of the comb member 25; however, it is preferable for the longer indexing tooth 26B or equivalent index member, to be in an intermediate or central position, as shown, so that during the moving stroke of the clamping arm 13, the indexing comb 25 comes to rest astride the sensor 22.

This makes it possible, with a same working stroke of the thrust member 16, to substantially reduce the size and lengthwise dimensions of the entire clamping apparatus, while providing a high number of control signals and detection of different operative positions of the clamping arm 13, by means of the other sensor 23.

In the example shown in FIGS. 1 and 2, the indexing means for actuating the sensors has been shown in the form of an elongated comb shaped member provided with a set of indexing teeth, namely, capable of providing indications relative to the various operative positions assumed by the arm 13.

It is obvious however that the detector device for detecting the positions of the arm 13, may also be differently shaped and disposed with respect to that shown, while still achieving the same result.

Therefore, in subsitution of the comb member 25, it is possible to use any other type of indexing device which extends linearly in the direction of the axis 18′ of the thrust member, and is provided on one of its sides, or on one of its edges, with a set of indexing elements functionally equivalent to the indexing teeth 26, again aligned and spaced apart in the direction of the axis 18′.

It is understood therefore that what has been described and shown with reference to the accompanying drawings, has been given purely by way of example in order to illustrate the general features of the invention and a preferential embodiments; it being understood that other modifications or variations may be made, both with regard to the clamping apparatus, and with regard to the means for supporting and adjusting the position of the sensors 22, 23, and with regard to the shape of the indexing means for the sensors, without thereby deviating from the scope, as specified in the claims.

What we claim is:

1. A clamping apparatus for clamping work pieces, the apparatus comprising:
a box-shaped casing having a longitudinal axis;
a clamping member, movably supported by the box- shaped casing;
said clamping member being operatively connected to a control actuator by a thrust member to be moved between a first and a second position; and
a detector device for detecting the clamping member in its operative positions, said detector device comprising at least a first detecting sensor, and
sensor actuating means connected to the movable thrust member, wherein
the sensor actuating means comprises a plurality of spaced apart and side by side arranged indexing members, said indexing members being longitudianlly aligned on a side of the thrust member facing said sensor of the detector device.

2. A clamping apparatus according to claim 1, wherein the sensor actuating means consists of a comb-shaped element.

3. A clamping apparatus according to claim 2, comprising:
a first sensor having an activating element at a first distance from the longitudinal axis of the thrust member;
a second sensor having an activating element at a second distance from the longitudinal axis of the thrust member, said second distance differing from the distance of the previous sensor; and
at least one of the teeth of the comb shaped element extending for a greater length compared to the other teeth.

4. A clamping apparatus according to claim 3, wherein the tooth of greater length is disposed centrally to the remaining teeth.

5. A clamping apparatus according to claim 1, wherein the sensor is adjustably secured to a support element in the longitudinal direction of the thrust member of the clamping device.
